(19) United States
(12) Patent Application Publication
(10) Pub. No.: US 2005/0222290 A1
(43) Pub. Date: Oct. 6, 2005

(54) Low-hardness thermosetting polyurethane elastomer and production method thereof

(76) Inventors: Tsutomu Tokushige, Kawabe-gun (JP); Takeshi Sanjo, Nishinomiya City (JP); Takashi Mano, Niihama City (JP)

Correspondence Address: BAYER MATERIAL SCIENCE LLC, 100 BAYER ROAD, PITTSBURGH, PA, 15205, US

(21) Appl. No.: 11/094,592

(22) Filed: Mar. 30, 2005

(30) Foreign Application Priority Data
Apr. 5, 2004 (JP) 111179-2004

(51) Int. Cl. C08J 9/00

(52) U.S. Cl. 521/155

(57) ABSTRACT

A process for the production of a low-hardness thermosetting polyurethane elastomer having a high curing rate, a low JIS A hardness of 10 to 40, a small compression set, a low moisture absorption, good dimensional stability and no bleeding property. In this process, a prepolymer formed from a difunctional polyol having a degree of total unsaturation of at most 0.01 meq/g and 4,4′-diphenylmethane diisocyanate alone or a polymethylene polyphenyl polyisocyanate containing 4,4′-diphenylmethane diisocyanate having an NCO content of 3 to 6% is reacted with a difunctional or trifunctional polyol having a degree of total unsaturation of at most 0.01 meq/g or a mixture thereof in the presence of a urethane reaction promoting catalyst.

### TECHNICAL FIELD OF THE INVENTION

The present invention relates to a thermosetting polyurethane elastomer (for example, polyurethane elastomer moldings) having a low hardness and to a method of producing it.

### BACKGROUND OF THE INVENTION

A thermosetting polyurethane elastomer is often used in, for example, OA apparatus parts such as an electric static roller, a developing roller, a transferring roller and a paper-forwarding roller used in a copying machine, a facsimile machine and the like by utilizing excellent properties such as mechanical properties and rubber-like elasticity.

The thermosetting polyurethane elastomer used in these applications, however, has been required to have good properties such as an even lower hardness (JIS A hardness: at most 40), a smaller compression set, better dimensional stability, and no bleeding property. Simultaneously with producing products having good properties, a production method having good output is also required so that the elastomer can be molded even in a mold at a relatively low temperature without decreasing the curing rate.

For the purpose of producing the thermosetting polyurethane elastomer having low hardness, it is known to add a large amount of plasticizer, but this method presents problems such as the deterioration of mechanical properties, the increase of compression set and the deterioration of surface tackiness caused by the bleeding of plasticizer.

It is also known to decrease crosslink density by using raw materials having low functionality, but this method yield products in which the mechanical properties such as compression set are deteriorated.

It is necessary to increase the activity of high molecular weight polyol used as raw materials and to increase the curing rate so that the low-hardness thermosetting polyurethane elastomer is produced at an acceptable rate when molded without decreasing the rate of cure even at a relatively low temperature. However, the high molecular weight polyol having the high activity has tendency toward increased moisture absorption (water absorption ratio), and consequent deterioration of dimensional stability.

It is known that to use a high molecular weight polyol having a low activity to reduce the moisture absorption. However, this method lowers productivity because of the decreased curing rate, the frequent presence of unreacted starting materials caused by low reactivity, and the deterioration of surface tackiness caused by the bleeding.

Accordingly, it would be desirable to develop a method for producing low-hardness thermosetting polyurethane elastomers having low moisture adsorption, good dimensional stability and high curing rate, which elastomers do not cause increased compression set and surface tackiness because of the bleeding, and molded articles having good characteristics produced by this method.

Several attempts to produce a thermosetting polyurethane elastomer having low hardness, small compression set, good moldability and no bleeding property, and the method of producing said elastomer have been made.

For example, JP-A-8-151423 describes a molded article of flexible thermosetting polyurethane elastomer which is produced from an isocyanate group-terminated prepolymer obtained by reacting diphenylmethane diisocyanate and/or carbodiimide-modified diphenylmethane diisocyanate with a high molecular weight polypropylene glycol having an average functional group number of 3 to 6, and a curing agent mainly comprising a high molecular weight polyfunctional polypropylene glycol.

JP-A-2003-252947 discloses a method for producing a thermosetting polyurethane elastomer without using a plasticizer in which toluene diisocyanate is reacted with a high molecular weight polyoxyalkylene polyol having an average hydroxyl group number of 2 to 3 and total unsaturation degree of at most 0.07 meq/g to produce an isocyanate-terminated prepolymer. This isocyanate group-terminated prepolymer is then reacted with a curing agent which is a high molecular weight polyoxyalkylene polyol having an average hydroxyl number of 2 to 3.

In the technology disclosed in JP-A-8-151423, because the isocyanate-terminated prepolymer based on the high molecular weight polyfunctional polypropylene glycol has a high viscosity, the polyurethane elastomer is disadvantageously difficult to work with and exhibits poor moldability. Because a low-activity polyoxypropylene glycol is used as the curing agent, the reaction is slow, molding should be conducted at a relatively high mold temperature, and unreacted polyoxypropylene glycol remains to cause bleeding.

In the method disclosed in JP-A-2003-252947, the slow speed of the reaction between the isocyanate group-terminated prepolymer and the curing agent results in the presence of unreacted polyol bleeding is easily caused, the need to use a large amount of catalyst to increase the curing rate and the need to mold the material at a relatively high mold temperature.

### SUMMARY OF THE INVENTION

It is an object of the present invention is to produce a low-hardness thermosetting polyurethane elastomer having a low JIS A hardness of 10 to 40, a small compression set, a low moisture absorption, good dimensional stability and no bleeding property, which can be molded without a decrease of curing rate even at a relatively low mold temperature.

This and other objects which will be apparent to those skilled in the art accomplished by reacting an isocyanate-terminated prepolymer produced with a low unsaturation polyol as described more fully herein and a curing agent.

### DETAILED DESCRIPTION OF THE INVENTION

The present inventors intensively studied to solve the above problems, and then discovered the following low-hardness thermosetting polyurethane elastomer and a method of producing it and completed the present invention.

The present invention relates to a method for producing a low-hardness thermosetting polyurethane elastomer, comprising mixing and reacting (1) an isocyanate group-terminated prepolymer, (2) a curing agent and optionally, an additive, etc. The isocyanate group-terminated prepolymer (1) is formed from (1a) an organic polyisocyanate and (1b) a polyol. The organic polyisocyanate (1a) is 4,4′-diphenylmethane diisocyanate alone or a polymethylene polyphenyl polyisocyanate containing 4,4′-diphenylmethane diisocyanate.

The polyol (1b) comprises a polyoxypropylene glycol having a degree of total unsaturation of at most 0.01 meq/g and a hydroxyl group number of 2.

The curing agent (2) comprises (2a) a polyol and (2b) a catalyst for urethane formation., The polyol (2a) comprises a polyoxyalkylene polyol having a degree of total unsaturation of at most 0.01 meq/g and a hydroxyl group number of 2 to 3.

The low-hardness thermosetting polyurethane elastomers of the present invention exhibit a compression set of at most 3% according to JIS K 7312, and a JIS A hardness of 10 to 40 by a Spring-type hardness tester according to JIS K 7312.

The low-hardness thermosetting polyurethane elastomer is generally a molded article.

### Effect of the Invention

The use of the above-mentioned specific composition can give the low-hardness thermosetting polyurethane elastomer having the compression set of at most 3% according to JIS K 7312, the JIS A hardness of 10 to 40, low moisture absorption, good dimensional stability, no bleeding and good productivity, which can be molded without a decrease of curing rate even at a relatively low mold temperature produced.

The isocyanate group-terminated prepolymer (1) used in the present invention is preferably prepared from an organic polyisocyanate (1a) and a polyol (1b) in a conventional method.

The organic polyisocyanate (1a) used in the present invention is 4,4′-diphenylmethane diisocyanate alone or a polymethylene polyphenyl polyisocyanate containing 4,4′-diphenylmethane diisocyanate.

4,4′-Diphenylmethane diisocyanate is diphenylmethane diisocyanate having two NCO groups and two benzene rings in one molecule, is referred to as “binuclear substance”, and contains isomeric 2,2′- and 2,4′-diphenylmethane diisocyanate in a small amount. The total content of 2,2′- and 2,4′-diphenylmethane diisocyanate contained in the 4,4′-diphenylmethane diisocyanate is usually at most 3% by weight, preferably at most 2% by weight. When the total content of 2,2′- and 2,4′-diphenylmethane diisocyanate is at most 3 by weight, the curing rate is high, and the bleeding and the like do not occur.

The polymethylene polyphenyl polyisocyanate containing 4,4′-diphenylmethane diisocyanate is composed of binuclear diphenylmethane diisocyanate, and a polynuclear substance having at least three NCO groups and benzene rings in one molecule. The content of the binuclear 4,4′-diphenylmethane diisocyanate in the polymethylene polyphenyl polyisocyanate containing 4,4′-diphenylmethane diisocyanate is preferably at least 65% by weight, more preferably at least 75% by weight. 85% by weight is most preferable. The total content of 2,2′- and 2,4′-diphenylmethane diisocyanate is preferably at most 3% by weight, more preferably at most 2% by weight.

The polyol (1b) used in the present invention may be a polyoxypropylene glycol having a total unsaturated degree of at most 0.01 meq/g, which is prepared by adding propylene oxide to propylene glycol or water as a starting material in the presence of a catalyst. Particularly preferred is a polyoxypropylene glycol having a secondary terminal hydroxyl group which is prepared in the presence of a double metal cyanide complex (DMC) as the catalyst.

Since the polyoxypropylene glycol having a secondary terminal hydroxyl group does not have the added ethylene oxide so that it is not hydrophilic, the molded article has low moisture absorption and good stability.

The number average molecular weight of the polyoxypropylene glycol may be from 5,000 to 20,000, preferably from 8,000 to 12,000. The molecular weight in the range between 5,000 and 20,000 gives a molded article having low hardness and small compression set.

The polyoxypropylene glycol may be a mixture of at least two, and the mixture preferably has a number average molecular weight of 5,000 to 20,000 and a total unsaturation degree of at most 0.01 meq/g as in the above-mentioned range. If the total unsaturation degree of the polyoxypropylene glycol is larger than 0.01 meq/g, disadvantageously, a large amount of monools are present to increase a molecular weight between crosslinked sites and to increase the compression set. In addition, the unreacted monools bleed to cause a problem of surface adhesion. The isocyanate group-terminated prepolymer (1) can be prepared by any conventional method, for example, by mixing and stirring 4,4′-diphenylmethane diisocyanate alone or the polymethylene polyphenyl polyisocyanate containing 4,4′-diphenylmethane diisocyanate with polyoxypropylene glycol having the total unsaturation degree of at most 0.01 meq/g under dry nitrogen gas stream at 70 to 100° C. for 5 to 30 hours to heat and react them.

The isocyanate group content of the isocyanate group-terminated prepolymer (1) is preferably from 3% to 6% by weight, more preferably from 4% to 5% by weight. When the content of isocyanate group is from 3% to 6% by weight, the prepolymer has a low viscosity, gives good workability, makes it unlikely that a bad molding will be produced, and makes it easy to achieve a low hardness.

The isocyanate group-terminated prepolymer (1) preferably has a viscosity in the range between 5,000 and 25,000 mPa·s/25° C., more preferably between 9,000 and 15,000 mPa·s/25° C.

The curing agent (2) used in the present invention comprises a polyol (2a) and a catalyst for urethane formation (2b).

The polyol (2a) used in the present invention is a polyoxyalkylene polyol having 2 to 3 hydroxyl groups and a total unsaturation degree of at most 0.01 meq/g. The number of carbon atoms in the oxyalkylene group in the polyoxyalkylene polyol may be from 2 to 10, preferably from 2 to 4. The polyoxyalkylene polyol can be prepared by adding, for example, propylene oxide and/or ethylene oxide to a starting material in the presence of a catalyst. A polyoxyalkylene polyol having a primary terminal hydroxyl group which is prepared by using a double metal cyanide complex (DMC) as the catalyst is particularly preferably.

The starting material suitable for the present invention is a dihydric or trihydric polyhydroxyl compound. Specific examples of suitable starting materials include ethylene glycol, propylene glycol, glycerin and trimethylol propane.

The number average molecular weight of the polyoxyalkylene polyol may be from 2,000 to 10,000, preferably from 4,000 to 6,000. When the number average molecular weight is from 2,000 to 10,000, a molded article having low hardness and small compression set can be obtained.

If the average hydroxyl group number is smaller than 2, a molecular weight between the crosslinking sites is large to give the low hardness, but the compression set is large. In addition, if the average hydroxyl group number is smaller than 2, the amount of monool is large so that bleeding and residual surface tackiness are undesirably caused. If the average hydroxyl group number is larger than 3, the molecular weight between crosslinking sites is undesirably decreased to increase the hardness.

The total unsaturation degree of the polyoxyalkylene polyol is at most 0.01 meq/g. If the total unsaturation is larger than 0.01 meq/g, a large amount of monool is present so that the unreacted monool bleeds to give residual surface tackiness and the compression set is large.

The proportion of primary terminal hydroxyl groups is preferably at least 80%, more preferably at least 85%. Because the terminal group is primary, the polyoxyalkylene polyol is advantageously highly activated so that the curing reaction between the polyoxyalkylene polyol and the isocyanate group-terminated prepolymer (1) can be conducted with a small amount of the catalyst, and the unreacted polyoxyalkylene polyol advantageously does not remain so that the bleeding is absent and the surface tackiness is eliminated.

The polyoxyalkylene polyol may be a mixture of at least two, and the mixture preferably has an average hydroxyl number of 2 to 3, a number average molecular weight of 2,000 to 10,000 and a total unsaturation degree of at most 0.01 meq/g.

Any of the conventional, known catalysts for the urethane reaction may be used as the catalyst for urethane formation (2b) in the practice of the present invention. Examples of suitable catalysts include organic tin catalysts such as dibutyltin dilaurate, dioctyltin dilaurate and dibutyltin dioctoate; an amine catalyst such as triethylamine, triethylene diamine, 1,8-diazabicycloundecene (DBU), or a phenol salt, octylate salt and paratoluenesulfonate salt thereof. Among them, DBU salts are preferable, since the pot life is long at room temperature and the reaction is increased at a temperature of at least 70° C. to accelerate the curing.

The amount of the catalyst in the curing agent is preferably from 0.005 to 0.1 parts by weight, based on 100 parts by weight of the polyoxyalkylene polyol of the curing agent. 0.01 to 0.05 part by weight is more preferable. The amount of 0.005 to 0.1 parts by weight give a high curing rate (that is, a short period of time till the molded article is demoldable) while maintaining a sufficient pot life.

In addition to the isocyanate group-terminated prepolymer (1) and the curing agent (2), any of the known additives such as a filler, stabilizer, a flame retardant, an electrically conducting agent and a mildew proofing agent may be added the reaction mixture.

Examples of suitable fillers include carbon black, aluminum hydroxide, calcium carbonate, titanium oxide, silica, talc and mica. Examples of the stabilizer include an antioxidant, an ultraviolet absorbing agent and a light stabilizing agent. Examples of the flame retardant include an alkyl phosphate and an organic bromine compound. Examples of a suitable electrically conducting agent include an organic lithium salt, an organic sulfonium salt and carbon black.

The low-hardness thermosetting polyurethane elastomer molded article can be produced by reacting the isocyanate group-terminated prepolymer (1) with the polyol (2a) in the curing agent (2). In the reaction between the isocyanate group-terminated prepolymer (1) and the polyol (2a), an equivalent ratio of the isocyanate group in the isocyanate group-terminated prepolymer (1) to the active hydrogen (particularly the hydroxyl group) in the polyol (2a) is preferably from 0.95 to 1.2, more preferably from 1.0 to 1.1. When the ratio is from 0.95 to 1.2, good compression set, strength and dimensional stability are obtained without causing the problem of the bleeding.

The low-hardness thermosetting polyurethane elastomer molded article can be molded by mixing the isocyanate group-terminated prepolymer (1) and the curing agent (2) and thermally curing them in a mold. In this case, the temperature of the mold is preferably from 60 to 100° C., most preferably from 70 to 90° C. The temperature of 60 to 100° C. results in easy casting, sufficient reaction and the completion of curing in a short period of time without bad curing. The resultant molded article can be demolded, thermally cured at 60 to 80° C. for 5 to 15 hours and cured at room temperature for one week to complete the reaction.

Any of the known methods for casting the reaction mixture into the mold may be used in the practice of the present invention. One suitable method is cast molding.

By adjusting the pot life to from 10 to 20 seconds, e.g., by means of the urethane formation catalyst and the like, the reaction mixture can be directly poured from an outlet of a machine onto a rotating rod for a roller to mold a roller in a rotation molding method which is a special molding method.

The resultant molded article preferably has a compression set of 3%, most preferably, at most 1.0% according to JIS K 7312. The JIS A hardness of the spring-type hardness tester defined by JIS K 7312 is preferably from 10 to 40, more preferably, from 15 to 35. The water absorption ratio is preferably at most 5.0%, particularly at most 4.0%. That is, the low-hardness thermosetting polyurethane elastomer molded article of the present invention has a compression set which is small while low hardness is maintained, the moisture absorption (the water absorption ratio) is small, the bleeding is eliminated, and the curing rate is not decreased even at a relatively low mold temperature. It also has the advantage that it is possible to use various processing methods such as a general casting method and a rotation molding method which is a specialized molding method.

### EXAMPLES

The following Examples and Comparative Examples further illustrate the present invention in detail. The present invention is not restricted by these Examples. Parts and % in these examples are in parts by weight and weight %, respectively, unless otherwise mentioned.

The measurement and the evaluation in the following Examples and Comparative Examples were conducted according to the following methods.

Content of Isocyanate Group (NCO Content)

The measurement was conducted according to JIS K1603.

Hydroxyl Group Value

The measurement was conducted according to JIS K1557.

Compression Set

According to JIS K 7312, the sample having a diameter of 29 mm and a thickness of 12.7 mm was compressed and fixed to 75% of thickness and then the compressed and fixed sample was heated at 70 degrees C. for 22 hours.

After that the compressed and fixed samples were decontrolled and the decontrolled sample was left for 30 minutes at room temperature and then the thickness of the left sample was measured.

Hardness

According to JIS K 7312, the hardness of the sheet having a thickness of 12 mm was measured by type A of spring type hardness tester.

Tensile Test

According to JIS K 7312, the dumbbell No. 3 test piece having a thickness of 2 mm was measured at the tensile speed of 500 mm/min. under the atmosphere of 23° C. and 65% RH.

Curing Rate

The mixture of the isocyanate group-terminated prepolymer and the curing agent was poured onto the hot iron plate having the same temperature as a mold. The mixture on the hot iron plate was cut by a spatula at a constant intervals, and the period of time when cutting line did not close by the curing from the initiation of mixing was determined to express a pot life and a cure rate.

Water Absorption Ratio

The water absorption ratio relating to hygroscopicity was measured as a criterion of hygroscopicity. The evaluation was that hygroscopicity was large in case of high value of water absorption ratio and hygroscopicity was small in case of low value of water absorption ratio. According to JIS K7312, the sheet-shaped specimen having thickness of 2 mm× width of 20 mm× length of 50 mm was weighted as initial weight and then was immersed into the ion exchanged water for 22 hours at 23° C. and then the immersed specimen was removed and weighed after removing excess water on the surface by wiping off. The weight change was calculated from the weight of the specimens before and after they were put in the water.

Bleeding Property (Surface Tackiness)

The strip-shaped polyethylene film was pushed on the surface of the molded article and the bleeding property (surface tackiness) was evaluated by visual observation whether or not a deposit substance existed on the surface of the said strip-shaped polyethylene film.

Evaluation Criterion:

O (good: no deposit substance on the surface film)

X (not good: some deposit substance on the surface film)

The polyoxypropylene glycol shown in Table 1 was used as a raw material for the isocyanate group-terminated prepolymer. The polyoxyalkylene polyol shown in Table 2 was used as a component for the curing agent.

The organic polyisocyanate shown in Table 3 was used as a raw material for the isocyanate group-terminated prepolymer. The isocyanate group-terminated prepolymer made from 4,4′-diphenylmethane diisocyanate alone or a polymethylene polyphenyl polyisocyanate containing 4,4′-diphenylmethane diisocyanate is also shown in Table 3.

### Example 1

The isocyanate group-terminated prepolymer F was prepared by the reaction of 150 parts of 4,4′-diphenylmethane diisocyanate with 850 parts of polyol A under the dry nitrogen sealed condition for 30 hours at 90° C. and then cooling. The resultant isocyanate group-terminated prepolymer had a NCO content of 4.0% and a viscosity of 9,700 mPa·s/25° C.

The curing agent was prepared by blending 10 parts of polyol C, 90 parts of polyol D and 0.02 parts of DBU octyl acid salt.

54 Parts of the prepolymer F controlled at 70° C. and 100.02 parts of the curing agent controlled at 25° C. (the equivalent ratio of NCO group and hydroxyl group of the curing agent is 1.03) were mixed by a propeller mixer for 1 minute and then poured into a hot metal mold which was controlled at 80° C. and was cured in the heating cabinet for 30 minutes and demolded. The pot life of the mixture was 5 minutes. The demolded molding was heated for 10 hours at 80° C. Additionally, after the molding was after-cured for 7 days under the atmosphere of 25° C. and 60% RH, the physical properties of the resultant molding were measured. The measured physical properties of the moldings are shown in Table 4. The JIS A hardness was 35 and a compression set was 0.7%. Additionally, the moldings showed no bleeding. All physical properties of the moldings satisfied the target.

### Example 2

The isocyanate group-terminated prepolymer G was prepared by the reaction of 142 parts of 4,4′-diphenylmethane diisocyanate with 858 parts of polyol B in the same manner as in Example 1. The resultant isocyanate group-terminated prepolymer G had a NCO content of 4.0% and a viscosity of 15,000 mPa·s/25° C.

The molding was obtained in the same manner as in Example 1 with the exception that the prepolymer G was used. The pot life of mixture was 5 minutes. The measured physical properties of the resultant molding are shown in Table 3. The JIS A hardness was 28 and the compression set was 1.0%. Additionally, the moldings showed no bleeding. All physical properties of the molding satisfied the target.

### Example 3

The isocyanate group-terminated prepolymer H was prepared by the reaction of 155.3 parts of polymethylene polyphenyl isocyanate containing 65 wt % of 4,4′-diphenylmethane diisocyanate with 844.7 parts of polyol A in the same manner as in Example 1. The resultant isocyanate group-terminated prepolymer had a NCO content of 4.0% and a viscosity of 15,000 mPa·s/25° C.

The molding was obtained in the same manner as in Example 1 with the exception that prepolymer H was used. The pot life of the mixture was 5 minutes. The measured physical properties of the resultant moldings are shown in Table 3. The JIS A hardness was 33, and the compression set was 1.0%. The moldings showed no bleeding. All physical properties of the moldings satisfied the target.

### Comparative Example 1

The isocyanate group-terminated prepolymer I was prepared by reaction of polymethylene polyphenyl isocyanate containing 50 wt % of 4,4′-diphenylmethane diisocyanate and at least 15% of 2,4′-diphenylmethane diisocyanate with a polyoxypropylene glycol having a molecular weight of 800. The isocyanate group-terminated prepolymer I had a NCO content of 28% and a viscosity of 130 mPa·s/25° C.

The curing agent was prepared by blending 50 parts of polyol C, 50 parts of polyol D and 0.02 parts of DBU octyl acid salt. The molding was obtained in the same manner as in Example 1 with the exception that 8 parts of isocyanate group-terminated prepolymer I controlled at 25° C. and 100.02 parts of curing agent controlled at 25° C. were mixed in a propeller mixer for 1 minute. The pot life of this mixture was 10 minutes. The measured physical properties of the resultant moldings are shown in Table 3. JIS A hardness was 38 and the compression set was 4.2%. Additionally, water absorption ratio was increased to 5.7% because the primary hydroxyl content of the polyoxyalkylene polyol in the polyurethane elastomer component was increased. The moldings did not satisfy the target.

### Comparative Example 2

The isocyanate group-terminated prepolymer J was prepared by reaction of 4,4′-diphenylmethane diisocyanate with dipropylene glycol. The resultant isocyanate group-terminated prepolymer J had a NCO content of 23% and a viscosity of 700 mPa·s/25° C. 3.1 parts of 1,4-butane diol as a chain extender were mixed to a curing agent consisting of 96.9 parts of polyol (1) A and 0.02 parts of DBU octyl acid salt.

The molding was obtained in the same manner as in Example 1 with the exception that 25 parts of isocyanate group-terminated prepolymer J controlled at 25° C. and 100.02 parts of mixture of 1,4-butane diol and curing agent controlled at 25° C. were mixed in a propeller mixer for 1 minute. The measured physical properties of the resultant moldings are shown in Table 3. The JIS A hardness was 42 and the compression set was 6.7%. The molding showed bleeding. Where dipropylene glycol having low molecular weight was used for the polyurethane elastomer component, it caused difficulties in achieving low hardness, low compression set, and bleeding occurred from molding. The physical properties did not satisfy the target.

### Comparative Example 3

The molding was obtained in the same manner as in Example 1 with the exception that 100 parts of polyol E were used as the polyoxyalkylene polyol component of the curing agent.

The measured physical properties of the resultant moldings are shown in Table 3. The JIS A hardness was 43 and the compression set was 5.5%. Also the pot life of mixture was long, namely, 15 minutes. The resultant molding showed bleeding. In case of using the polyol having the high degree of total unsaturation and the low primary hydroxyl content, the physical properties of moldings did not satisfy the target.

TABLE 1
Polyoxypropylene glycol

| | | Number-average | Hydroxyl | The degree of total |
|---|---|---|---|---|
| Polyol | Starting | molecular | Group | unsaturation |
| (1) | material | weight | Number | (meq/g) |
| A | Propylene | 8,000 | 2 | 0.007 |
| | glycol | | | |
| B | Propylene | 12,000 | 2 | 0.01 |
| | glycol | | | |

TABLE 2
Polyoxyalkylene polyol

| | | | | The | |
|---|---|---|---|---|---|
| | | Number- | | degree of | Primary |
| Polyoxy- | | average | Hydroxyl | total | hydroxyl |
| alkylene | Starting | molecular | Group | unsaturation | content |
| polyol | material | weight | Number | (meq/g) | (%) |
| Polyol C | Propylene | 4,000 | 2 | 0.01 | 87 |
| | glycol | | | | |
| Polyol D | Glycerin | 6,000 | 3 | 0.01 | 87 |
| Polyol E | Glycerin | 3,000 | 3 | 0.05 | 40 |

TABLE 3
Isocyanate group-terminated prepolymer

| Isocyanate group-terminated prepolymer | | F | G | H |
|---|---|---|---|---|
| Organic | 4,4′- | 150 | 142 | |
| polyisocyanate | Diphenylmethane | | | |
| (parts by | diisocyanate | | | |
| weight) | Polymethylene | | | 155.3 |
| | polyphenyl | | | |
| | polyisocyanate | | | |
| | containing | | | |
| | 4,4′- | | | |
| | diphenylmethane | | | |
| | diisocyanate | | | |
| Polyoxypropylene | A (parts by weight) | 850 | | 844.7 |
| glycol | B (parts by weight) | | 858 | |

| | | | |
|---|---|---|---|
| NCO content (%) | 4.0 | 4.0 | 4.0 |
| Viscosity (mPa · s/25° C.) | 9,700 | 15,000 | 15,000 |

TABLE 4
Examples and Comparative Examples

| | | | | | Comparative | Comparative | Comparative |
|---|---|---|---|---|---|---|---|
| | | Example 1 | Example 2 | Example 3 | Example 1 | Example 2 | Example 3 |
| Isocyanate | F | 54 | — | — | — | — | 54 |
| group- | G | — | 54 | — | — | — | — |
| terminated | H | — | — | 54 | — | — | — |
| prepolymer | I | — | — | — | 8 | — | — |
| (parts by | J | — | — | — | — | 25 | — |
| weight) | | | | | | | |
| Curing agent | C | 10 | 10 | 10 | 50 | — | — |
| (parts by | D | 90 | 90 | 90 | 50 | — | — |
| weight) | A | — | — | — | — | 96.9 | — |
| | E | — | — | — | — | — | 100 |
| | DBU octyl | 0.02 | 0.02 | 0.02 | 0.02 | 0.02 | 0.02 |
| | acid salt | | | | | | |
| Chain | 1,4- | — | — | — | — | 3.1 | — |
| extender | Butanediol | | | | | | |
| (parts by | | | | | | | |
| weight) | | | | | | | |

| | | | | | | |
|---|---|---|---|---|---|---|
| Isocyanate-group- | 1.03 | 1.03 | 1.03 | 1.03 | 1.03 | 1.03 |
| terminated prepolymer/ | | | | | | |
| Curing agent | | | | | | |
| (NCO/OH equivalent ratio) | | | | | | |
| Curing rate | 5 | 5 | 5 | 10 | 3 | 15 |
| (pot life (min.)) | | | | | | |
| Temperature of mold | 80 | 80 | 80 | 80 | 80 | 80 |
| (° C.) | | | | | | |

Physical properties of molded articles

| | | | | | | | |
|---|---|---|---|---|---|---|---|
| Hardness | JIS A | 35 | 28 | 33 | 38 | 42 | 43 |
| Tensile | MPa | 1.2 | 1.2 | 1.0 | 1.1 | 4.1 | 1.4 |
| strength | | | | | | | |
| Elongation | % | 140 | 130 | 150 | 120 | 380 | 100 |
| Tearing | KN/m | 5.1 | 4.7 | 3.5 | 6.0 | 28.1 | 4.1 |
| strength | | | | | | | |
| Compression set | % | 0.7 | 1.0 | 1.0 | 4.2 | 6.7 | 5.5 |
| Bleeding | | ◯ | ◯ | ◯ | ◯ | X | X |
| property | | | | | | | |
| (surface | | | | | | | |
| tackiness) | | | | | | | |
| Water | % | 3.6 | 3.7 | 3.5 | 5.7 | 2.8 | 3.0 |
| absorption ratio | | | | | | | |

### INDUSTRIAL APPLICABILITY

The low-hardness thermosetting polyurethane elastomer molded article of the present invention is useful in the applications such as an electric static roller, a developing roller, a transferring roller, a paper-forwarding roller, a vibration insulator and a shock absorber used in a copying machine, a facsimile machine and the like.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of a low-hardness thermosetting polyurethane elastomer, comprising
a) mixing and reacting
(1) an isocyanate group-terminated prepolymer which is the reaction product of
(i) 4,4′-diphenylmethane diisocyanate or polymethylene polyphenyl polyisocyanate containing 4,4′-diphenylmethane diisocyanate,
and
(ii) a polyoxypropylene glycol having a total unsaturation level no greater than 0.01 meq/g and a hydroxyl group functionality of 2,
with
(2) a curing agent comprising
(i) a polyoxyalkylene polyol having a total unsaturation level no greater than 0.01 meq/g and a hydroxyl group functionality of from 2 to 3.
and
(ii) a urethane reaction promoting catalyst,
and, (3) optionally, one or more additives.

2. The process of claim 1 in which the isocyanate group-terminated prepolymer has an isocyanate group content of from 3% to 6% by weight.

3. The process of claim 1 in which polyoxyalkylene polyol (2i) has a ratio of primary hydroxyl groups to terminal hydroxyl groups of at least 80%.

4. A low-hardness thermosetting polyurethane elastomer produced by the process of claim 1 which exhibits a compression set of at most 3% according to JIS K7312 and a JIS A hardness of 10 to 40 as measured by a Spring-type hardness tester according to JIS K 7312.

5. The polyurethane elastomer of claim 4 which is a molded article.
